(19) United States
(12) Patent Application Publication
(10) Pub. No.: US 2025/0089698 A1
(43) Pub. Date: Mar. 20, 2025

(54) DETACHABLE HOOD FOR RODENT TRAP

(71) Applicant: David Schuelke, Park City, UT (US)

(72) Inventor: David Schuelke, Park City, UT (US)

(21) Appl. No.: 18/468,649

(22) Filed: Sep. 15, 2023

(51) Int. Cl. A01M 23/24; A01M 23/30

(52) U.S. Cl. CPC A01M 23/245; A01M 23/30

(57) ABSTRACT

A hood operable to detachably affix to a standard rodent snap trap. A base plate of a standard snap trap slides into a track defined by the hood in some embodiments. The hood defines an open forward end into which a rodent enters, being obstructed from lateral entry by sidewalls of the enclosure.

### FIELD OF THE INVENTION

This invention relates to rodent traps and more particularly relates to rodent traps adapted primarily for catching rats and mice.

### BACKGROUND

### Description of the Related Art

Rodents, including mice and rats, can destroy articles of food, books, furnishing, and homes. Rodents can carry disease such as the hantavirus, and infestations may result in closure of commercial businesses. Rodents' gnawing, urine and feces can poison humans.

Preventing entry of rodents into residential and commercial settings may involve the sealing of cracks, spaces and openings such as vents and pipes and can be a labor and time intensive process which is not always successful. Most often, home owners turn to rodent extermination methods within structures rather than methods of trying to prevent rodent entry. Traditional methods of dealing with rodent invasions involve the use of poisoned baits (rodenticides) that contain anticoagulants, such as warfarin, pival and chlorophacinone. Mousetraps are often employed instead of poisoned baits. Traps are generally preferred as these are less hazardous to use around children and pets, but the snapping mechanisms incorporated into these traps can still harm children and domesticated animals and pets, such as dogs.

Because mice are caught by the trap, there is less chance of odor from mice dying in wall voids or other inaccessible areas after poisoning. Mousetraps in the form of wooden-based snap traps are common, but suffer from a number of shortcomings, including mice approaching the trap laterally and flipping the trap over in the process of activating it. These snap traps are more effective if a rodent approaches the trap perpendicularly to the snap mechanism.

Whilst recognizing the shortcomings of prior art mousetraps, the present inventors have sought to overcome these deficiencies with a hood or enclosure for a mousetrap that substantially isolates the trap mechanism from lateral approachment or ingress and forces a rodent to enter the trap head on.

Such a solution is desirably if simple and cost effective to manufacture and are also able to efficiently trap rodents such as mice and rats.

### SUMMARY

From the foregoing discussion, it should be apparent that a need exists for a detachable hood for a rodent trap. Accordingly, the present invention has been developed to provide a detachable hood for a rodent trap, the detachable hood comprising: an enclosure having an open forward end and an open rearward end, the enclosure defining a hollow interior recess into which a rodent enters; wherein a width of the enclosure is dimensioned not to exceed a lateral width of a hammer incorporated into the rodent snap trap such that the hammer is operable to circumscribe the enclosure when triggered; two protuberances jutting laterally from the enclosure and affixed inferiorly thereto, each protuberance defining: a hollow track recess, and a track on an interior surface for receiving a rectangular base of a rodent snap trap; wherein a width between exterior edges of each protuberance exceeds a width of the rectangular base.

In various embodiments, the enclosure may be fabricated from one of a molded polymeric material and stamped sheet metal.

An interior surface of each protuberance may comprise a cantilevered lip jutting interiorly into the hollow track recess.

The enclosure and protuberances may be formed as a single integrated piece.

A second detachable hood for a rodent trap is also provided, the second detachable hood comprising: an enclosure having an open forward end and a partially open rearward end, the enclosure defining a hollow interior recess into which a rodent enters; wherein a width of the enclosure is dimensioned not to exceed a lateral width of a hammer incorporated into the rodent snap trap such that the hammer is operable to circumscribe the enclosure when triggered; two protuberances jutting laterally from the enclosure and affixed inferiorly thereto, each protuberance comprising a cantilevered lip jutting interiorly into the hollow track recess, wherein a width between exterior edges of each protuberance exceeds a width of the rectangular base; wherein the enclosure and protuberances are formed as a single integrated piece.

The enclosure may be fabricated from one of a molded polymeric material and stamped sheet metal. An interior surface of each protuberance may comprise a cantilevered lip jutting interiorly into the hollow track recess. The enclosure and protuberances are formed as a single integrated piece in some embodiments.

The detachable hood may further comprise two or more lateral tabs extending laterally from a protuberance, each lateral tab defining a bore through which one of a nail and screw inserts.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric, perspective view illustrating one embodiment of a detachable hood for a rodent trap in accordance with the present invention;

FIG. 2A is an environmental, isometric, perspective view of one embodiment of a detachable hood for a rodent trap in accordance with the present invention;

FIG. 2B is an environmental, isometric, perspective view of one embodiment of a detachable hood for a rodent trap in accordance with the present invention;

FIG. 3 is an environmental, isometric, perspective view of one embodiment of a detachable hood for a rodent trap in accordance with the present invention; and

FIG. 4 is a forward perspective view of one embodiment of a detachable hood for a rodent trap in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided.

One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide an enclosure or hood for a standard snap trap.

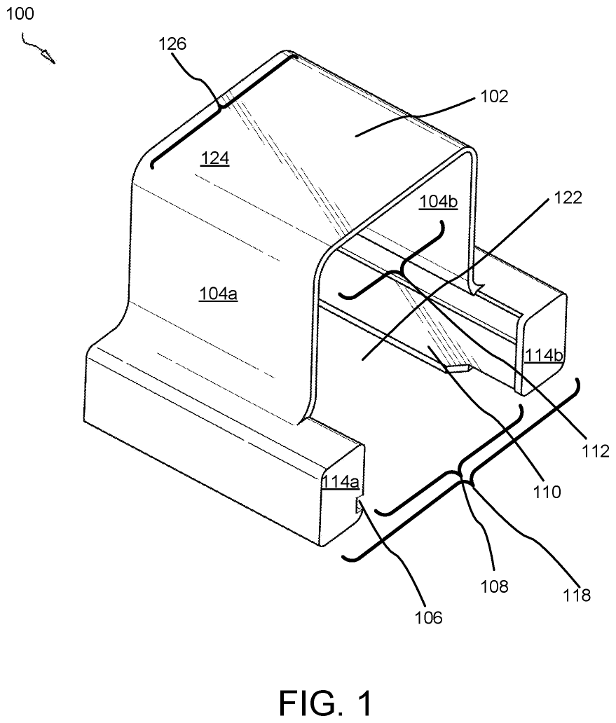

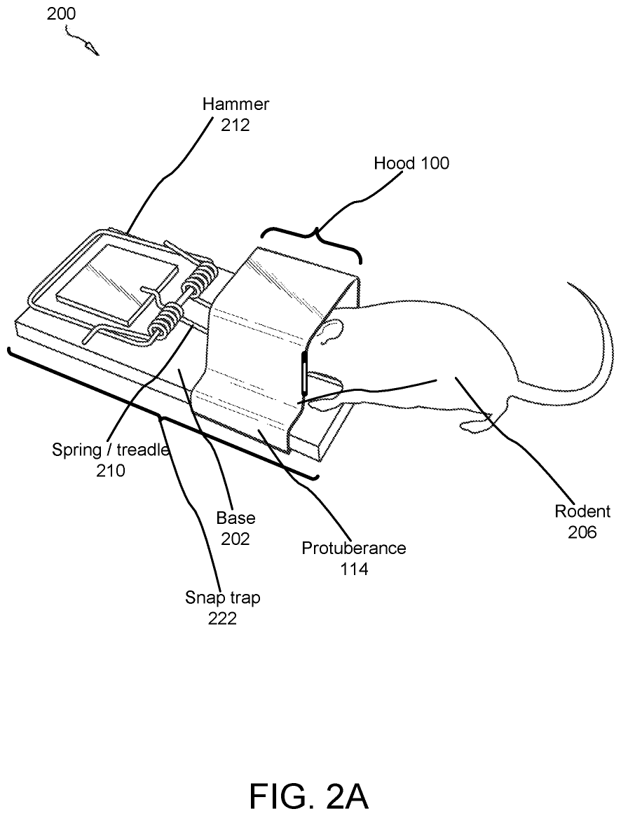

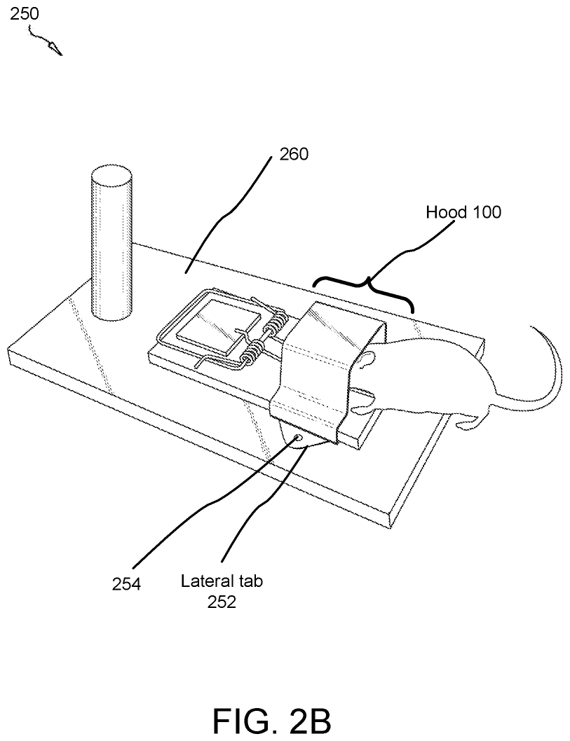

FIGS. 1-2A illustrate an isometric, perspective view of various embodiments of a detachable hood 100 for a rodent trap in accordance with the present invention.

In various embodiments, the detachable hood 100 comprises an enclosure 102 defining a hollow interior recess 112 into which the apparatus 100 is adapted to permit entry of rodent 206.

The enclosure 102 comprises, in the shown embodiment, two sidewalls 104a-b which position inferiorly to a top surface 124 of the enclosure 102.

The enclosure defines two open ends 122, an open forward end and an open rearward end. In various embodiments, the open rearward end may be partially enclosed such that only the treadle 210 of a standard snap trap traverses therethrough.

In various embodiments, the enclosure 102 defines a hollow interior recess 110 into which a rodent 206 enters through the open forward end 122.

Two protuberances 114a-b affix to a lower surface of the enclosure's 102 sidewalls 104. Each protuberance 114 affixes inferiorly to a lower surface (or edge) of a sidewall 104. In various embodiments, the enclosure 102 and protuberances 114 are formed as a single integrated piece. The sidewalls 104 and/or the entire enclosure 102 may be formed from a flexible or semi-flexible material such that the width 118 between protuberances 114 may be extended by insertion of a wider base 202 into the track 106. In this manner, the hood 106 may be formed to flex or fit a plurality of differing sized snap traps 222. This semi flexible material may include nylon, metal, metal alloys or organic materials such as leather or wood.

The width 126 of the enclosure 102 is dimensioned not to exceed the width of the hammer 212 (or jaws) of a conventional snap trap 222 such that the hammer 212 envelopes, or circumscribes, the exterior periphery of the enclosure 102 when triggered.

The protuberances 204, likewise, are dimensioned to exceed a width of the base 202 of the snap trap 222. The width 118 of the protuberances 114 is measured from exterior lateral edge of the protuberance 114a and the exterior lateral edge of the protuberances 114b. The width 118 exceeds the width of the base 202 such that the protuberances 204 slide over the lateral edges of the base 202.

A track recess 108 is defined by the protuberances 114a-b into which the base 202 of the snap trap 222 inserts.

In various embodiments, the protuberances 114 define a track 106 spanning the longitudinal plane of the base 202 (i.e., front to back) defined by the top surface of the base 202. The base 202 travels within the track 106. The hood 100 is detachable to the snap trap 222 in that the snap trap 222 slides into the protuberances 114.

In various embodiments, a cantilever or lip 110 juts inwardly from an interior lower edge of the protuberance 114. The base 202 may be adapted insert into the trap recess 108 above the lip 110.

In some embodiments, the protuberances 114 are longer longitudinally than the enclosure 102. The enclosure 102 is dimensioned to fit within the hammer 212. As such, the top surface 124 of the enclosure 102 in necessarily smaller in surface area than the area defined within the hammer 212.

The base 202 may be rectangular, square, ovoid or otherwise shaped.

It is an object of the present invention to provide a hood 100, 200 which obstructs lateral ingress of a rodent 206 to the trap 222 and forces a rodent 206 to enter through the open forward end 122 of the enclosure 102. The enclosure 102 may be dimensioned longitudinally to ensure the hammer 212 falls on the rodent's 206 neck.

FIG. 2B is an environmental, isometric, perspective view of one embodiment of a detachable hood 250 for a rodent trap in accordance with the present invention.

The hood 250 in the shown embodiment comprises two lateral tabs 252 (or wings) which jut laterally from the hood 250. These tabs 252 may have planar top and/or bottom surfaces and may define an aperture 254 through a nail or screw traverses and into which a nail or screw inserts.

The hood 250 may be bolted or screwed to the top surface of a bait station 260.

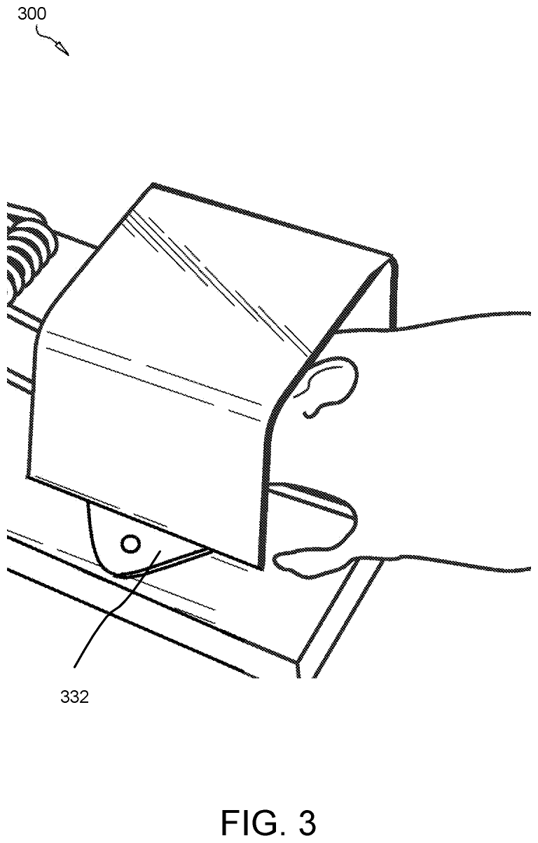

FIG. 3 is an environmental, isometric, perspective view of one embodiment of a detachable hood 300 for a rodent trap in accordance with the present invention.

In various embodiments, the tabs 252 are affixed directly to the sidewall of the hood 300. In this manner, tabs 332 are formed which are nail or screwed to the trap itself rather than bait station 260. In this manner, the hood 300 excludes the bait station 260 and means for sliding onto the trap.

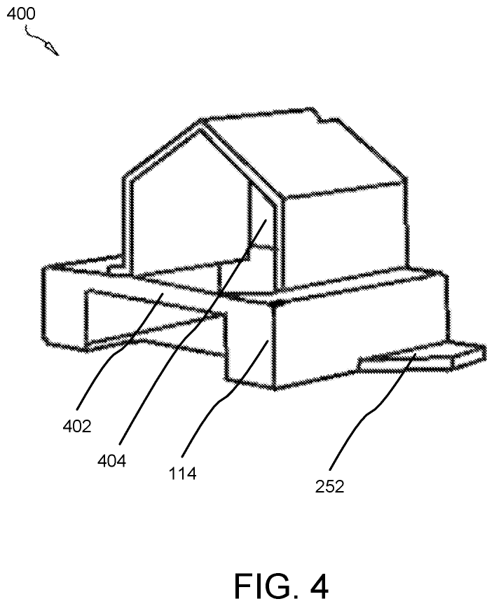

FIG. 4 is a forward perspective view of one embodiment of a detachable hood 400 for a rodent trap in accordance with the present invention.

In various embodiments, an open back end of the hood 400 is obstructed, or partially obstructed, with a back wall 404, which prevents rodents from entering the trap from the rear. The hood 400 may also comprise a horizontal beam 402 which positions below or in front of the open forward end 122 of the interior recess 112.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A detachable hood for a rodent trap, the detachable hood comprising:
an enclosure having an open forward end and an open rearward end, the enclosure defining a hollow interior recess into which a rodent enters;
wherein the open back end is partially obstructed to prevent rodents from entering the enclosure from the rear and dimensioned to receive a treadle of a snap trap;
wherein a width of the enclosure is dimensioned not to exceed a lateral width of a hammer incorporated into the rodent snap trap such that the hammer is operable to circumscribe the enclosure when triggered;
two protuberances jutting laterally from the enclosure and affixed inferiorly thereto, each protuberance defining:
a hollow track recess, and
a track on an interior surface for receiving a rectangular base of a rodent snap trap;
wherein a width between exterior edges of each protuberance exceeds a width of the rectangular base.

2. The detachable hood for a rodent trap of claim 1, wherein the enclosure is fabricated from one of a molded polymeric material and stamped sheet metal.

3. The detachable hood for a rodent trap of claim 1, wherein an interior surface of each protuberance comprises a cantilevered lip jutting interiorly into the hollow track recess.

4. The detachable hood for a rodent trap of claim 1, wherein the enclosure and protuberances are formed as a single integrated piece.

5. The detachable hood for a rodent trap of claim 1, further comprises two or more lateral tabs extending laterally, each lateral tab defining a bore through which one of a nail and screw inserts.

6. A detachable hood for a rodent trap, the detachable hood comprising:
an enclosure having an open forward end and a partially open rearward end, the enclosure defining a hollow interior recess into which a rodent enters;
wherein the open back end is partially obstructed to prevent rodents from entering the enclosure from the rear and dimensioned to receive a treadle of a snap trap;
a horizontal beam positioning in front of the open forward end;
wherein a width of the enclosure is dimensioned not to exceed a lateral width of a hammer incorporated into the rodent snap trap such that the hammer is operable to circumscribe the enclosure when triggered;
two protuberances jutting laterally from the enclosure and affixed inferiorly thereto, each protuberance comprising a cantilevered lip jutting interiorly into the hollow track recess;
wherein a width between exterior edges of each protuberance exceeds a width of the rectangular base;
wherein the enclosure and protuberances are formed as a single integrated piece.

7. The detachable hood for a rodent trap of claim 6, wherein the enclosure is fabricated from one of a molded polymeric material and stamped sheet metal.

8. The detachable hood for a rodent trap of claim 6, wherein an interior surface of each protuberance comprises a cantilevered lip jutting interiorly into the hollow track recess.

9. The detachable hood for a rodent trap of claim 6, wherein the enclosure and protuberances are formed as a single integrated piece.

10. The detachable hood for a rodent trap of claim 6, further comprises two or more lateral tabs extending laterally from a protuberance, each lateral tab defining a bore through which one of a nail and screw inserts.
